(19) United States
(12) Patent Application Publication
(10) Pub. No.: US 2019/0132042 A1
(43) Pub. Date: May 2, 2019

(54) RELAY STATION AND RELAY COVERAGE AREA CONTROL METHOD

(71) Applicant: JVC KENWOOD CORPORATION, Yokohama-shi (JP)

(72) Inventor: Kazuomi TACHIGI, Yokohama-shi (JP)

(21) Appl. No.: 16/171,406

(22) Filed: Oct. 26, 2018

(30) Foreign Application Priority Data
Oct. 31, 2017 (JP) 2017-210147

(51) Int. Cl. H04B 7/155; H04L 5/16

(52) U.S. Cl. CPC H04B 7/15507; H04W 88/02; H04L 5/16

(57) ABSTRACT

A transmitter and receiver receives relay station information from a second relay station. A processor decodes the relay station information. A controller performs control based on the decoded relay station information. The controller calculates an overlapping area where a relay coverage area of the relay station overlaps with a relay coverage area of the second relay station. The relay coverage area of the relay station is based on positional information of the relay station, and the relay coverage area of the second relay station is based on information indicating a relay coverage area of the second relay station included in the relay station information. The controller does not relay a signal transmitted from a mobile station located in the overlapping area.

### CROSS REFERENCE TO RELATED APPLICATION

This application is based upon and claims the benefit of priority under 35 U.S.C. § 119 from Japanese Patent Application No. 2017-210147 filed on Oct. 31, 2017, the entire contents of which are incorporated herein by reference.

### BACKGROUND

The present disclosure relates to a relay station which relays received data and a relay coverage area control method.

Radios that use a half-duplex communication method to transmit and receive various types of data are widely used. Some radios include a relay function that temporarily stores received data in a storage unit and then transmits the data, so that other radios receive the same data. Such radios that transmit received data by the relay function operate as relay stations that relay received data.

In order to cause a relay station to relay data, the mobile station needs to set a packet path (a relay path). The packet path is set by one of the following two methods: the first method is to directly specify a call sign of the relay station, like “J¥1AAA-1”; and the second method is to specify a common alias, which is assigned to plural relay stations, and the number of relay stages, like “WIDE1-1” or “WIDE1-1 and WIDE2-1”.

### SUMMARY

Many radios operate as relay stations with the popularization of a communication protocol called Automatic Packet Reporting System (APRS). In the case of using the aforementioned second method as the method of setting a packet path, relay stations moving in a flat area or an urban area are usually operated in a single-stage relay in which the packet path is set for a wide area like “WIDE 1-1”. This prevents congestion of radio waves that can occur in multi-stage relay and allows for efficient comfortable operation of relay stations.

Wide area-type relay stations are able to cover a radius of several tens or more kilometers. When some relay stations are located close to each other, data transmitted from a radio, including various packets, is sometimes simultaneously relayed by relay stations located close to each other. It is therefore necessary to prevent plural relay stations from relaying the same data unnecessarily.

A first aspect of one or more embodiments provides a relay station that relays a signal transmitted from a mobile station, including: a transmitter and receiver configured to receive relay station information from a second relay station, the second relay station being another relay station; a processor configured to decode the relay station information; and a controller configured to perform control based on the decoded relay station information, wherein the controller calculates an overlapping area where a relay coverage area of the relay station overlaps with a relay coverage area of the second relay station, the relay coverage area of the relay station being based on positional information of the relay station, and the relay coverage area of the second relay station being based on information indicating a relay coverage area of the second relay station included in the relay station information, and wherein the controller does not relay a signal transmitted from a mobile station located in the overlapping area.

A second aspect of one or more embodiments provides a relay coverage area control method, including: by a relay station, receiving information indicating a relay coverage area of a second relay station from the second relay station, the second relay station being another relay station; by the relay station, calculating a relay coverage area of the relay station; and by the relay station, not relaying a signal transmitted from a mobile station located in an overlapping area where a relay coverage area of the relay station overlaps with a relay coverage area of the second relay station.

### BRIEF DESCRIPTION OF THE DRAWINGS

FIG. 1 is a block diagram illustrating a configuration example of a radio constituting a relay station according to one or more embodiments.

FIG. 2 is a diagram illustrating a situation where a mobile station is located in an overlapping relay coverage area of plural relay stations, and data relay by plural relay stations is avoided by the operation of the relay station according to one or more embodiments.

FIG. 3 is a flowchart illustrating a process of the relay station according to one or more embodiments to acquire relay station information and create a relay station list.

FIG. 4 is a flowchart illustrating a specific process to calculate a relay coverage area of the local station in step S6 illustrated in FIG. 3.

FIG. 5 is a flowchart illustrating a relay transmission process by the relay station according to one or more embodiments.

FIG. 6 is a block diagram illustrating an internal functional configuration example of a controller included in the relay station according to one or more embodiments, when the controller executes the relay transmission process.

### DETAILED DESCRIPTION

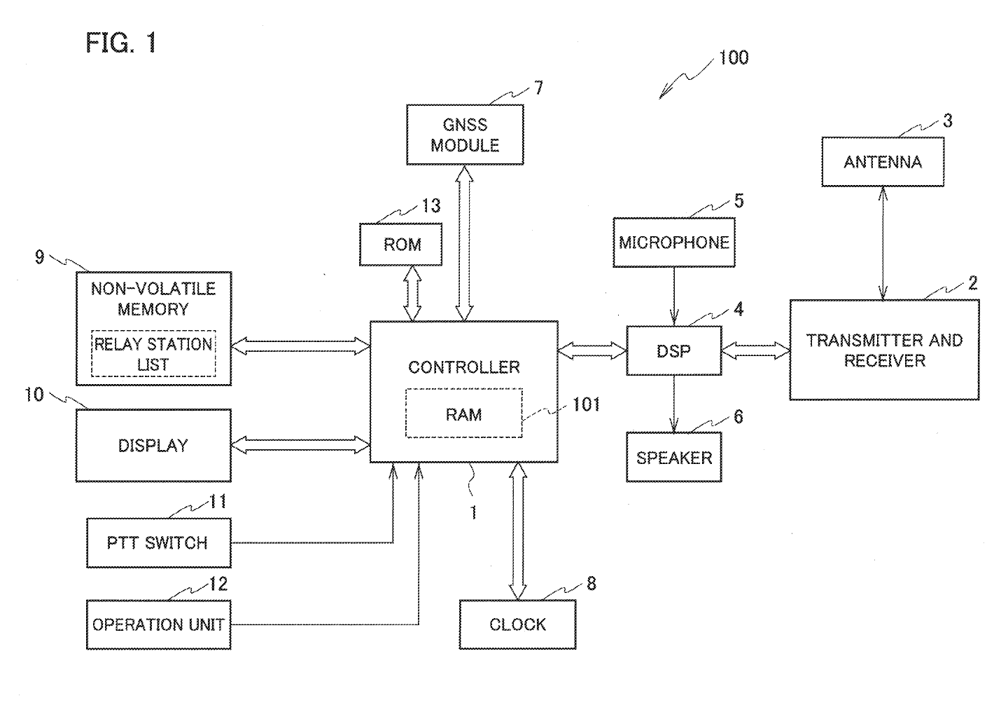

Hereinafter, a relay station and a relay coverage area control method according to one or more embodiments will be described with reference to the accompanying drawings. First, using FIG. 1, a description is given of a whole configuration example and operation of a radio 100 that sometimes operates as a relay station. The radio 100 is an FM radio transmitting and receiving frequency-modulated data, as an example.

In FIG. 1, a controller 1 controls the entire radio 100. The controller 1 can be composed of a microcomputer or a central processing unit (CPU). The controller 1 includes a built-in RAM 101. The RAM 101 may be externally attached to the controller 1.

The controller 1 connects to a digital signal processor (DSP) 4. The DSP 4 is an example of a processor. The DSP 4 connects to a transmitter and receiver 2, a microphone 5, and a speaker 6. The transmitter and receiver 2 connects to an antenna 3 to transmit and receive radio waves. The transmitter and receiver 2 is a circuit block integrally composed of a transmitter and a receiver.

The transmitter and receiver 2 transmits data to another radio 100 in the half-duplex communication method. The transmitter and receiver 2 receives data transmitted from another radio 100 in half-duplex communication method. Any one of the other radios 100 operate as relay stations in some cases. The local radio (local station) 100 also serves as a relay station in some cases.

The data received by the transmitter and receiver 2 is supplied to the DSP 4. The DSP 4 demodulates the received data and decodes strings of letters in packets included in the data. The DSP 4 then supplies the decoded strings to the controller 1. When the transmitter and receiver 2 receives voice data, the DSP 4 D/A coverts the received voice data, then supplies the created voice signal by demodulation and decoding to the speaker 6.

The microphone 5 picks up vocal sounds emitted from the user of the radio 100, converts the vocal sounds into a voice signal, and then supplies the voice signal to the DSP 4. The DSP 4 A/D converts the inputted voice signal and performs various types of processing, including band limiting, for the converted voice signal to create modulation waves. The DSP 4 supplies the created modulation waves to the transmitter and receiver 2. The transmitter and receiver 2 modulates a carrier wave with the modulation waves supplied from the DSP 4 into a frequency-modulated signal. The transmitter and receiver 2 transmits the frequency-modulated signal via the antenna 3.

The controller 1 further connects to a GNSS module 7, a clock 8, a non-volatile memory 9, a display 10, a push-to-talk (PTT) switch 11, an operation unit 12, and a ROM 13.

The GNSS module 7 includes: an antenna that receives radio waves from satellites of the global navigation satellite system (GNSS); and a receiver that receives GNSS signal outputted from the antenna. The GNSS is the global positioning system (GPS), as an example.

The GNSS module 7 acquires positional information of the place where the radio 100 is located, and supplies the acquired positional information to the controller 1. The GNSS module 7 is an example of a positional information acquisition unit that acquires the positional information of the local station. When the radio 100 is a fixed station, not a mobile station, the positional information of the radio 100 may be stored in the non-volatile memory 9.

The clock 8 is a real time clock (RTC), as an example. Time information from the clock 8 is used as a time stamp. The non-volatile memory 9 stores a later-described relay station list. The non-volatile memory 9 is an electrically erasable programmable read-only memory (EEPROM), for example.

In order for the user to speak and transmit voice signals, the user presses the PTT switch 11. The controller 1 sets the radio 100 to a reception standby mode when the PTT switch 11 is not pressed, and sets the radio 100 to a transmission mode when the PTT switch 11 is pressed. The operation unit 12 includes various operation keys. The operation unit 12 is operated to configure the radio 100 as a relay station.

The ROM 13 as an example of the storage unit stores a computer program (a relay transmission program) that causes the controller 1 to perform relay transmission of data (hereinafter, referred to as relay target data) which is transmitted from a mobile station and is a target to be relayed when the radio 100 is a relay station, as described later. The ROM 13 may be built in the controller 1.

In FIG. 1, white arrows indicate a bus connecting the constituent elements. Instead of the bus, the constituent elements may be connected with normal signal connecting lines.

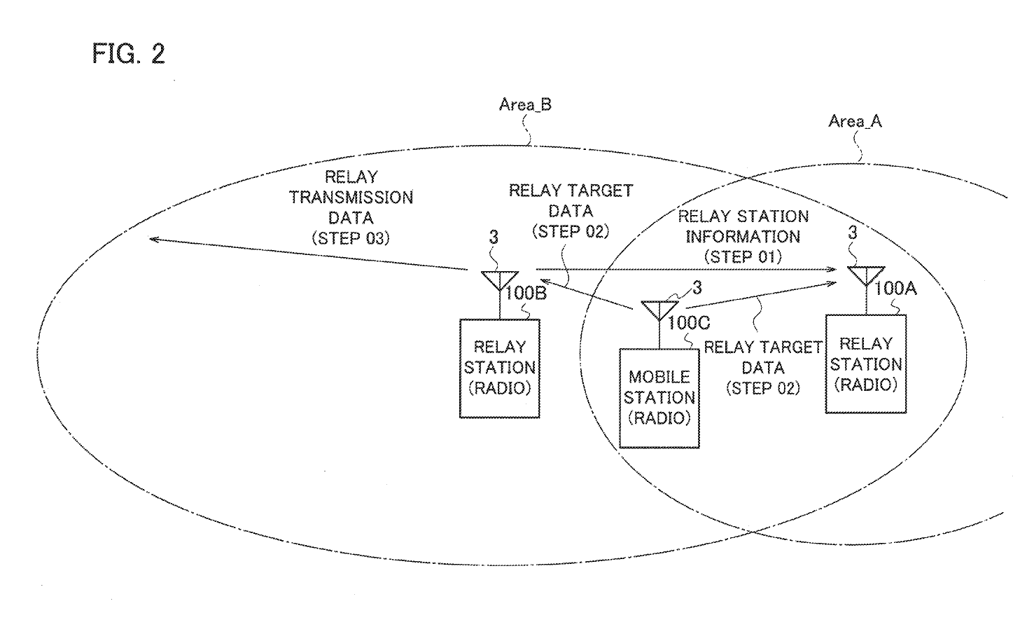

In FIG. 2, each of relay stations 100A and 100B is the radio 100 operating as a relay station. A mobile station 100C is the radio 100 not operating as a relay station. In the relay stations 100A and 100B, the alias is set to the same “WIDE1-1”.

As illustrated in FIG. 2, a relay coverage area Area_A of the relay station 100A and a relay coverage area Area_B of the relay station 100B partially overlap each other. The mobile station 100C is located in both the relay coverage areas Area_A and Area_B. When the mobile station 100C specifies “WIDE1-1” as the packet path, both of the relay stations 100A and 100B relay data transmitted from the mobile station 100C.

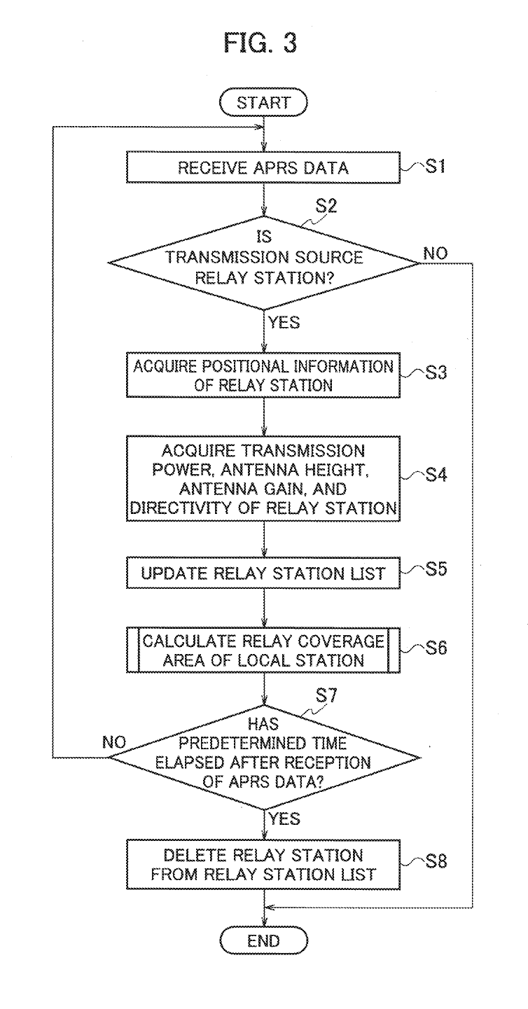

In one or more embodiments, the radio 100 is configured to execute processes illustrated in FIGS. 3 to 5 in order to avoid relay of the same data by plural relay stations. When plural relay stations are close to each other, each relay station sometimes receives relay station information including a positional information packet (beacon) from other relay stations. In FIG. 2, a description is given in which the relay station 100A receives the relay station information transmitted from the relay station 100B, and executes the processes illustrated in FIGS. 3 to 5.

In FIG. 3, the relay station 100A receives APRS data transmitted from the relay station 100B in step S1. The relay station 100B transmits APRS data at predetermined time intervals. The APRS data includes relay station information 26 including a positional information packet indicating the positional information of the relay station 100B, source call sign, APRS icon information, transmission power, antenna height, antenna gain, and directivity for the transmission of radio waves.

The controller 1 of the relay station 100A determines whether the transmission source of the APRS data is a relay station in step S2. It can be determined whether the transmission source is a relay station, based on the SSID (1 to 4) of the source call sign and the ARPS icon information. When the transmission source is not a relay station (NO), the controller 1 terminates the process.

When the transmission source is a relay station (YES), the controller 1 moves the process to step S3. In the step S3, the controller 1 acquires the positional information of the relay station 100B from the positional information packet. In step S4, the controller 1 acquires the transmission power, antenna height, antenna gain, and directivity of the relay station 100B.

In step S5, the controller 1 updates the relay station list in the non-volatile memory 9. In step S6, the controller 1 calculates the relay coverage area of the local station (the relay station 100A). The specific method of calculating the relay coverage area in the step S6 is described later. In step S7, the controller 1 determines whether a predetermined time has elapsed after reception of the APRS data. The predetermined time is set much longer than time intervals at which the relay station 100B transmits the APRS data.

When the predetermined time has elapsed after reception of the APRS data (YES), it is determined that the relay station 100B has moved to a position where the relay station 100A cannot receive the APRS data from the relay station 100B. In step S8, the controller 1 deletes the relay station (herein, the relay station 100B) from the relay station list and terminates the process. When the predetermined time has not elapsed after reception of the APRS data (NO), the controller 1 returns the process to the step S1 and repeats the step 1 and the subsequent steps.

The controller 1 regularly executes the process to acquire the relay station information, illustrated in FIG. 3, to continuously update the relay station list including information concerning one or plural relay stations in the neighborhood of the local station.

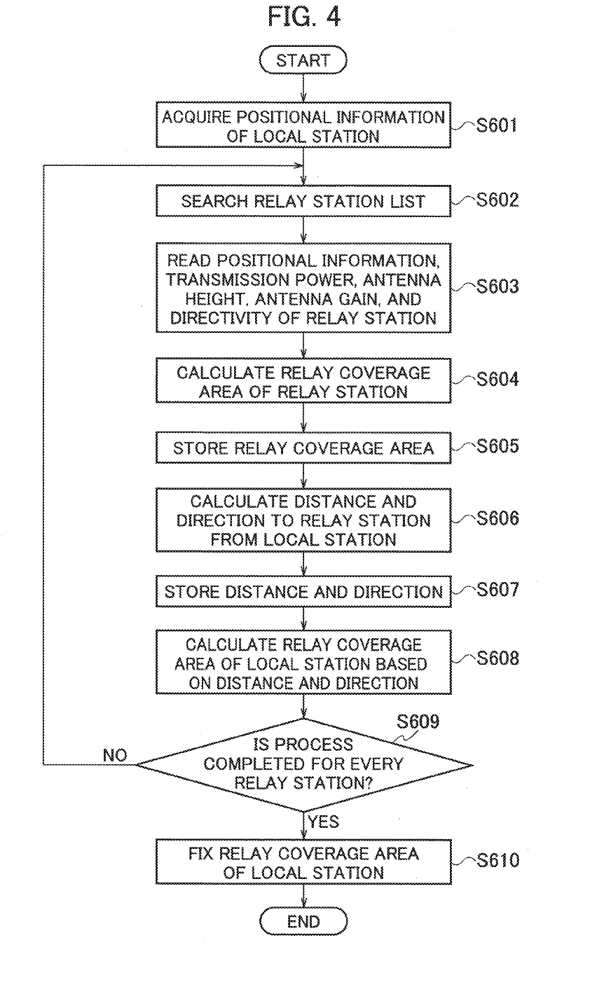

Using FIG. 4, the method of calculating the relay coverage area of the local station in step S6 is specifically described. In FIG. 4, the controller 1 acquires the positional information of the local station in step S601 and searches the relay station list in step S602. In step S603, the controller 1 selects one of the relay stations stored in the relay station list and reads the transmission power, antenna height, antenna gain, and directivity of the selected relay station.

In step S604, the controller 1 calculates the relay coverage area of the selected relay station based on the transmission power, antenna height, antenna gain, and directivity. The higher the transmission power, the wider the relay coverage area. The antenna height is the altitude position of the antenna. The higher the antenna height, the wider the relay coverage area. The higher the antenna gain, the wider the relay coverage area. When the antenna is directional in transmitting radio waves, the relay coverage area is not an area 360 degrees around the relay station but an arc area with a predetermined angle.

The controller 1 calculates the relay coverage area of the relay station based on the transmission power, antenna height, antenna gain, and directivity herein. However, the controller 1 may calculate the relay coverage area based on only the transmission power. When the transmission power is 10 W, the relay coverage area corresponds to a range of 20 km with a radius of about 10 km, for example.

In addition, the controller 1 may calculate the relay coverage area of another relay station (a second relay station) by comparing the antenna height of the anther relay station with that of the local station. When the antenna height of the local area is greater than that of another relay station, the controller 1 corrects the transmission power of another relay station to a lower value and then calculates the relay coverage area.

The controller 1 preferably calculates the relay coverage area based on at least one of the antenna height, antenna gain, and directivity in addition to the transmission power. This allows for more accurate calculation of the relay coverage area. The controller 1 may calculate the relay coverage area based on the directivity in addition to the transmission power. Most preferably, the controller 1 calculates the relay coverage area based on all of the transmission power, antenna height, antenna gain, and directivity.

As described above, the information that can contribute to calculation of the relay coverage area is considered as information indicating the relay coverage area. If the range in which another relay station can relay data is provided as the positional information by another relay station, for example, the provided information may be utilized as the information indicating the relay coverage area.

In step S605, the controller 1 stores the calculated relay coverage area in the non-volatile memory 9 in association with the selected relay station. In step S606, the controller 1 calculates the distance between the selected relay station and the local station, and the direction of the selected relay station from the local station. In step S607, the controller 1 temporarily stores the distance and direction of the selected relay station in the storage unit such as the RAM 101.

In step S608, the controller 1 calculates the relay coverage area of the local station based on the distance and direction to the selected relay station. The calculation of the relay coverage area of the local station in the step S608 is recalculation to correct the relay coverage area of the local station previously calculated.

Specifically, the controller 1 calculates the relay coverage area of the local station in advance based on the transmission power, antenna height, antenna gain, and directivity of the local station, and stores the calculated relay coverage area of the local station in the non-volatile memory 9. The relay coverage area of the local station calculated herein is the relay coverage area of the local station alone, not considering relay coverage areas of other relay stations.

As for the relay coverage area of the local station, similarly to the relay coverage areas of other relay stations, the controller 1 may calculate the relay coverage area based on only the transmission power, or may calculate the relay coverage area based on at least one of the antenna height, antenna gain, or directivity in addition to the transmission power. The controller 1 may calculate the relay coverage area based on the directivity in addition to the transmission power. The controller 1 may calculate the relay coverage area based on all of the transmission power, antenna height, antenna gain, and directivity.

The controller 1 can calculate which area of the relay coverage areas of the local station overlaps with the relay coverage areas of the selected relay station, based on the distance to the selected relay station and direction of the selected relay station. In step S608, based on the distance to the selected relay station and the direction of the selected relaying station, the controller 1 calculates a new relay coverage area of the local station by excluding an area (overlapping area) overlapping with the relay coverage areas of the selected relay station from the relay coverage area of the local station, and temporarily stores the calculated new relay coverage area of the local station in the storage unit, such as the RAM 101.

Subsequently, in step S609, the controller 1 determines whether the process in the steps S602 to S608 is completed for all the relay stations stored in the relay station list. When the process is not completed for all the relay stations, the controller 1 repeats the process in the steps S602 to S608. When the process is completed for all the relay stations, in the step S608, the final relay coverage area of the local station is calculated by excluding the areas overlapping with the relay coverage areas of all of the other relay stations from the relay coverage area of the local station.

In step S610, the controller 1 fixes the relay coverage area of the local station and stores the fixed relay coverage area of the local station in the non-volatile memory 9, thus terminating the process.

In FIG. 2, when the relay station 100A receives the relay station information from the relay station 100B in step 01, the process illustrated in FIGS. 3 and 4 is executed. The relay station 100A thereby calculates the relay coverage area of the local station (the relay station 100A) excluding the area overlapping with the relay coverage area of the relay station 100B, and holds the calculated relay coverage area.

In FIG. 2, the mobile station 100C transmits relay target data intended to be relayed in step 02. The call sign of the mobile station 100C is AAAAAA-7, for example. In this case, the relay target data is AAAAAA-7>APK01, WIDE1-1:!xx.xx.xx N/yyy.yy.yy E-Test, as an example. AAAAAA-7 indicates the source address field; APK01 indicates the destination address field; WIDE1-1 indicates the relay station address field; and !xx.xx.xx N/yyy.yy.yy E-Test indicates the information field. The information field herein indicates the positional information of the mobile station. xx.xx.xx N indicates a latitude of xx.xx.xx (degrees, minutes, seconds) north while yyy.yy.yy E indicates a longitude of yyy.yy.yy (degrees, minutes, seconds) east.

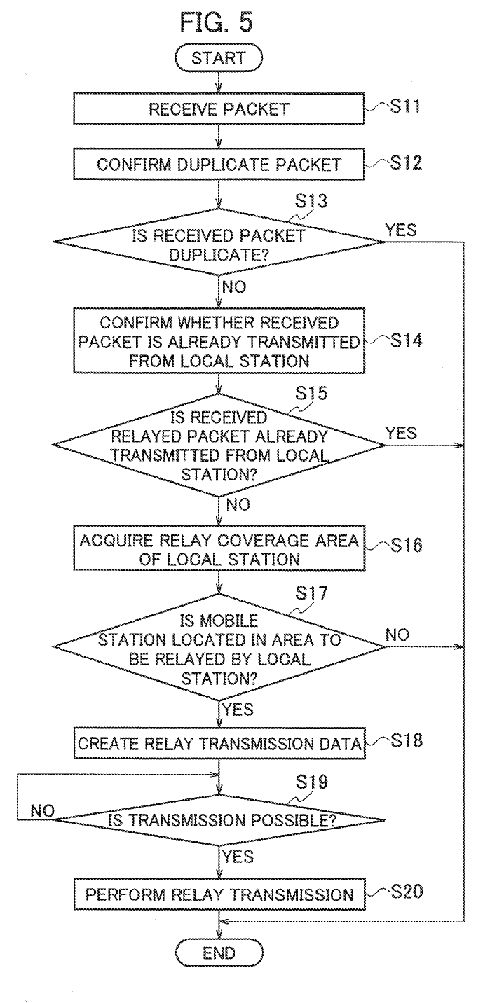

The controller 1 of the relay station 100A stores the relay target data which is a transmission signal from the mobile station 100C in the RAM 101, and executes the relay process illustrated in FIG. 5.

In FIG. 5, the controller 1 receives packets included in the transmission data transmitted from the mobile station 100C in step S11. The packets include at least a positional information packet. The packets may include a positional information packet and a message packet. The controller 1 specifies the position of the mobile station from the received positional information packet.

In step 12, the controller 1 confirms whether the received packets are duplicate packets which are the same as some packets already received in a predetermined period of time. When the received packets are duplicate packets (YES) in step S13, the controller 1 terminates the process. When the received packets are not duplicate packets (NO), the controller 1 then confirms whether the received packets have been relayed by the local station in step S14. The controller 1 can confirm whether the received packets have been relayed by the local station by verifying the check sum.

When determining that the received packets have been already relayed (YES) in step S15, the controller 1 terminates the process. When the determining that the received packets have not been relayed yet (NO), the controller 1 acquires the relay coverage area of the local station stored in the non-volatile memory 9 in step S16. The relay coverage area of the local station herein is the relay coverage area which is fixed in the step S608 of FIG. 4, and excluding the area overlapping the relay coverage areas of the other relay stations.

In step S17, the controller 1 determines whether the mobile station 100C is located in the fixed relay coverage area of the local station. When the mobile station 100C is not located in the relay coverage area of the local station (NO), the packets will be relayed by another relay station, and the controller 1 terminates the process. When the mobile station 100C is located in the relay coverage area of the local station (YES), the controller 1 creates data to be transmitted and relayed (hereinafter, referred to as relay transmission data) based on the relay target data which is stored in the RAM 101 in step S18.

In step S19, the controller 1 determines whether the relay transmission data can be transmitted. For example, the relay transmission data cannot be transmitted when the PTT switch 11 is pressed and the relay station 100A is in the transmission mode. When the relay transmission data cannot be transmitted (NO), the controller 1 repeats the process of the step S19 and remains in the standby mode until the relay transmission data can be transmitted. When the relay transmission data can be transmitted (YES), the controller 1 relays and transmits the relay transmission data in the step S20.

By the aforementioned processes, the relay station 100A does not relay and transmit the relay transmission data since the mobile station 100C is located in the relay coverage area Area_B of the relay station 100B as illustrated in FIG. 2. Only the relay station 100B relays and transmits the relay transmission data in the step 03.

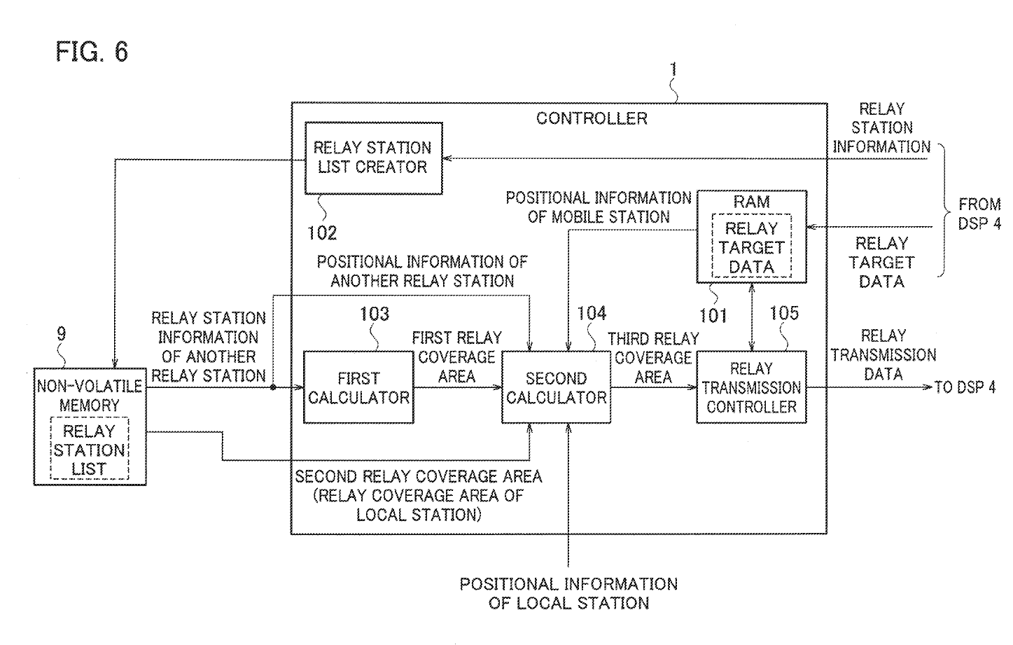

The controller 1 is able to execute the processes illustrated in FIGS. 3 to 5 with the functional configuration illustrated in FIG. 6. In FIG. 6, a relay station list creator 102 creates a list of relay stations based on the relay station information of the APRS data received from other relay stations and stores the created list in the non-volatile memory 9. The relay station list creator 102 creates the relay station list including a list of only relay stations, the relay station information of which is acquired in a predetermined period of time. The relay station list creator 102 thus continuously updates the created list of relay stations.

A first calculator 103 calculates a first relay coverage area based on the relay station information that is transmitted from another relay station and includes at least the positional information and transmission power of another relay station. The first relay coverage area is an area in which another relay station is able to receive and relay data.

The relay coverage area in which the local relay station is able to transmit and relay received data independently, not considering the first relay coverage area of another relay station, is referred to as a second relay coverage area. A second calculator 104 calculates a third relay coverage area of the local relay station based on the distance between the local relay station and another relay station, and the direction of another relay station from the local relay station. The third relay coverage area is a corrected relay coverage area of the local station, and is calculated by excluding the area overlapping with the first relay coverage area from the second relay coverage area.

Based on the positional information of the mobile station transmitted from the mobile station, a relay transmission controller 105 performs control so as to perform relay transmission of data which is transmitted from a mobile terminal and is intended to be relayed, when the mobile station is not located in the first relay coverage area but in the third relay coverage area.

As descried above, according to the relay station according to one or more embodiments, it is possible to relay data while avoiding relay of the same data by plural relay stations.

What is claimed is:

1. A relay station that relays a signal transmitted from a mobile station, comprising:
a transmitter and receiver configured to receive relay station information from a second relay station, the second relay station being another relay station;
a processor configured to decode the relay station information; and
a controller configured to perform control based on the decoded relay station information,
wherein the controller calculates an overlapping area where a relay coverage area of the relay station overlaps with a relay coverage area of the second relay station, the relay coverage area of the relay station being based on positional information of the relay station, and the relay coverage area of the second relay station being based on information indicating a relay coverage area of the second relay station included in the relay station information,
and wherein the controller does not relay a signal transmitted from a mobile station located in the overlapping area.

2. The relay station according to claim 1, wherein
the relay station information includes at least positional information of the second relay station and transmission power with which the second relay station transmits radio waves,
the controller comprises:
a first calculator configured to calculate, based on the relay station information, a first relay coverage area where the second relay station is able to receive data, and relay and transmit the received data;
a second calculator configured to calculate a third relay coverage area excluding an area overlapping with the first relay coverage area from a second relay coverage area, the second relay coverage area being an area where the relay station is able to receive, relay, and transmit the received data, based on a distance between the relay station and the second relay station and a direction of the second relay station from the relay station, and
a relay transmission controller configured to control, so as to relay and transmit a relay target data which is transmitted by the mobile station, when the mobile station is not located in the first relay coverage area but is located in the third relay coverage area, based on the positional information of the mobile station that is transmitted from the mobile station.

3. The relay station according to claim 2,
wherein the controller further comprises a relay station list creator configured to create a relay station list including a list of only other relay stations the relay station information of which is acquired in a predetermined period of time,
and wherein the second calculator calculates the third relay coverage area by correcting the second relay coverage area based on only the first relay coverage area of each of the relay stations stored in the relay station list.

4. The relay station according to claim 2, wherein the first calculator calculates the first relay coverage area based on, in addition to the transmission power, at least one of antenna height, antenna gain, and radio wave transmission directivity, as the relay station information of the second relay station.

5. A relay coverage area control method, comprising:
by a relay station, receiving information indicating a relay coverage area of a second relay station from the second relay station, the second relay station being another relay station;
by the relay station, calculating a relay coverage area of the relay station; and
by the relay station, not relaying a signal transmitted from a mobile station located in an overlapping area where a relay coverage area of the relay station overlaps with a relay coverage area of the second relay station.

6. The relay coverage area control method according to claim 5, wherein the relay station relays a signal transmitted from a mobile station located in the relay coverage area of the relay station excluding the overlapping area.

7. The relay coverage area control method according to claim 5, wherein the relay station enables relay of a signal transmitted from a mobile station located in the overlapping area, when a predetermined period of time elapsed after reception of the information.
